(19) United States
(12) Patent Application Publication
(10) Pub. No.: US 2021/0278222 A1
(43) Pub. Date: Sep. 9, 2021

(54) GENERATING A NEW HYBRID MAP FOR NAVIGATION

(71) Applicant: SICK AG, Waldkirch (DE)

(72) Inventors: Fabian FISCHER, Waldkirch (DE); Bastian STEDER, Waldkirch (DE); Patrick SCHOPP, Waldkirch (DE)

(21) Appl. No.: 17/192,545

(22) Filed: Mar. 4, 2021

(30) Foreign Application Priority Data
Mar. 5, 2020 (EP) 20161070.6

(51) Int. Cl. G01C 21/32; G06K 9/62; G05D 1/00; G05D 1/02

(52) U.S. Cl. CPC G01C 21/32; G06K 9/6204; G05D 1/0088; G05D 2201/0216; G05D 1/0274; G06K 9/6289; G05D 1/0221

(57) ABSTRACT

A method for generating a new hybrid map by at least one of extending and modifying a first hybrid map with a second hybrid map, the hybrid map being used for the navigation of a vehicle (10) in a navigation area and including a plurality of information categories, one information category comprising a trajectory of the vehicle (10) to be driven, which trajectory is predefined by a trail (12), and one information category comprising a surrounding contour (24) of the trail (12), wherein a transfer decision is made for each of the information categories as to whether information from the first hybrid map, the second hybrid map, or both the first hybrid map and the second hybrid map is transferred to the new hybrid map.

The invention relates to a method and a mapping apparatus for generating a new hybrid map by extending and/or modifying a first hybrid map with a second hybrid map.

A conventional navigation method for driverless transport vehicles (AGV, Automated Guided Vehicle) is based on guidance by a physical trail or guideline. The track, trail or line is, for example, stuck to the ground or embedded in the ground as an optically detectable tape or magnetic tape and is detected by means of suitable sensor technology, such as a camera or a Hall sensor. A trail guidance sensor outputs the respective distance to the center of the trail, and this information is used to control travel in such a way that the vehicle continuously follows the trail.

In addition to the trails, additional markers or codes are used in some cases to transmit control signals to the vehicle at certain positions, for example to slow down or turn into a certain direction. The additional markers often function as position codes with an absolute position indication in coordinates known to the vehicle control system. Additional markers are arranged on the ground or embedded in the ground along the trail. The vehicle has a code reader in technology matching the additional marker, i.e. an optical code reader for a barcode or 2D code or an RFID reader for an RFID tag.

Trails embedded in the ground can only be changed with great effort and are therefore used less and less. Trails sticking on the ground are easier to change, but are subject to high stress during operation of the system. Wear and dirt can then lead to faulty control, or the vehicle is no longer able to continue on the specified trail until the defects are rectified by service personnel.

As an alternative to trail or line guidance, navigation methods are known that are based on contactless contour detection of the environment. The natural contours the vehicle uses for orientation and self-location can be supplemented or replaced everywhere or at critical points by specifically attached reflectors. A required map with contour information of the environment is either created in advance or is generated during navigation (SLAM, Simultaneous Localization and Mapping). Here, the vehicle must find its way on its own by means of path planning. This is much more complex and time-consuming than the above-mentioned method with trail guidance. If there is a problem with the path planning, trained personnel must be deployed.

In order to combine the advantages of the flexibility of free navigation with the simple path planning of trail guidance, navigation systems that can be described as virtual trail guidance systems are proposed in the state of the art. Here, the vehicle travels along a physical trail in a teach-in or modification phase and generates a map of its surroundings. The system memorizes the trail virtually as a roadway or trajectory. In a following and now free operating phase, the vehicle navigates along the specified trajectory based on a contour measurement of the environment and the map, so that the formerly physical trail now acts as a virtual trail. The further fate of the physical trail becomes irrelevant. This method has the advantage of a particularly simple conversion, since the existing physical trail is transferred and thus its information maintained. The virtual trail guidance system can even give the same control commands to the vehicle control system as the replaced trail guidance sensor did before. Additional codes or markers can also be detected during teach-in and replaced by virtual additional codes at their positions.

A virtual trail guidance system is described, for example, in the German patent application DE 10 2019 123 659.2 that, as of yet, has not been published. A virtual trail following and conversion method for autonomous vehicles is known from EP 3 167 342 B1. The document EP 2 818 954 A2 discloses a driverless transport vehicle and a method for planning a virtual trail. However, in this case, the virtual trail is planned only on a computer from the beginning. WO 2018/051081 A1 deals with the adaptation of a trail-following AGV.

Again and again, situations arise where the map is out of date. For example, routes have changed, in particular due to subsequent editing of a virtual trail, new areas have been added, reflectors have failed or additional reflector have been installed, new additional codes have been attached, or the environment has changed significantly compared to the originally mapped contour information.

It is known to re-acquire the map. However, remapping involves a lot of effort, since the complete environment has to be traversed again, and any manual changes to the map are lost or have to be repeated. In addition, the coordinate system may change, making the positions stored by the user invalid and requiring another configuration. Alternatively, some methods update their map continuously. However, this ultimately only distributes these disadvantages to smaller steps.

It is therefore an object of the invention to improve the updating of a map for navigating a vehicle.

This object is satisfied by a method for generating a new hybrid map by at least one of extending and modifying a first hybrid map with a second hybrid map, the hybrid map being used for the navigation of a vehicle in a navigation area and including a plurality of information categories, one information category comprising a trajectory of the vehicle to be driven, which trajectory is predefined by a trail, and one information category comprising a surrounding contour of the trail, wherein a transfer decision is made for each of the information categories as to whether information from the first hybrid map, the second hybrid map, or both the first hybrid map and the second hybrid map is transferred to the new hybrid map.

The object is also satisfied by a mapping apparatus for generating a new hybrid map for the navigation of a vehicle, the device having a contour detection sensor for detecting an environmental contour of an environment of the vehicle and a control and evaluation unit configured to execute a method for generating the new hybrid map by at least one of extending and modifying a first hybrid map with a second hybrid map, the hybrid map being used for the navigation of a vehicle in a navigation area and including a plurality of information categories, one information category comprising a trajectory of the vehicle to be driven, which trajectory is predefined by a trail, and one information category comprising a surrounding contour of the trail, wherein a transfer decision is made for each of the information categories as to whether information from the first hybrid map, the second hybrid map, or both the first hybrid map and the second hybrid map is transferred to the new hybrid map.

A vehicle, in particular an autonomous vehicle (AGV, automated guided vehicle) uses the hybrid map for self-localization when navigating along a predetermined trajectory given by a trail or line. A first hybrid map is an original map, for example from a partial mapping or which has already been used for a certain operational phase. This first hybrid map is modified using a second hybrid map. This may involve adding an area that the first hybrid map did not cover, revisiting an area, or the second map contributing a combination of both. A new hybrid map is created from a union of the first and second hybrid maps. Accordingly, a third and additional hybrid maps can be added incrementally.

A hybrid map includes a plurality of categories of information that may originate from different sensors. Accordingly, the hybrid map has information of different types. One of the information categories concerns the trail or track or the trajectory to be travelled by the vehicle. Another information category concerns the environmental contour of the trail, which is detected in particular during a mapping tour along the trail with a contour detection sensor.

The invention starts from the basic idea of creating a possibility not to replace the hybrid map completely. Instead, the information categories are updated separately according to different rules. For this purpose, a transfer decision is made for each information category as to whether the new hybrid map takes over information of this information category from the first hybrid map, the second hybrid map, or a combination of information from both hybrid maps. The question of whether information is transferred in an information category can also be answered in the negative. In this case, the corresponding information category is missing in the new hybrid map, at least in some areas.

The invention has the advantage that only parts of a map are flexibly updated, i.e. spatially limited sub-areas and/or only certain information categories, while other parts remain untouched. The costs of new mapping (remapping) is considerably reduced, since only relevant locations with changes have to be remapped and not the entire navigation area. The trajectories entered in the old map can continue to be used to travel the specified path, even if they are (meanwhile) purely virtual. A complete new mapping, on the other hand, would require trails to be physically present, or the vehicle to be controlled in some other way, such as manually. Likewise, changes made in the old map, for example by editing a virtual trail, are not lost. The coordinate system of the old map can be maintained, so that stored positions retain their validity.

The first hybrid map preferably is generated in a first mapping process and/or the second hybrid map is generated in a second mapping process at a later time, wherein in a mapping process the vehicle travels along at least parts of the trail and records the surrounding contour of the trail with a contour detection sensor. Throughout this specification, the terms preferably or preferred refer to advantageous, but completely optional features. During the teach-in or reference tour, navigation can still be performed using a conventional trail guidance system based on a physical trail. The mapping, and in particular the post-mapping, i.e. the acquisition of the second hybrid map, can also be done along a virtual trail. In addition, it is not necessary to travel along the entire trail, in particular during new mapping. It is a matter of traveling through those sub-areas that require updating. A preferred method for the mapping is described in the German patent application with file number 10 2019 123 659.2 mentioned above and its U.S. counterpart Ser. No. 17/008,921, which is herewith incorporated by reference.

In an operational phase following the mapping and merging of the first and second hybrid maps, the vehicle navigates with the help of the new hybrid map. A contour detection sensor is used to detect a respective contour of the vehicle's surroundings. This is preferably the same contour detection sensor that was used for mapping. An environment contour in particular is a point cloud, generally a 3D point cloud, but may be, for example, confined to a plane and thus effectively only be a 2D point cloud, as in a distance-measuring laser scanner. Based on the surrounding contours, the vehicle's own pose is repeatedly determined and the vehicle thus navigated. A pose can be determined in up to six degrees of freedom, with a position and/or orientation of the vehicle in one to three degrees of freedom each.

The transfer decision preferably is made by a specification per information category, in particular by a selection in a user interface. In this preferred embodiment, there is a set rule per information category as to which information from the first hybrid map is to be retained, replaced by the second hybrid map, combined from both, or possibly not transferred at all to the new hybrid map. This rule can be parameterized or entered via a user interface, for example.

The transfer decision preferably is made automatically. In particular, criteria or rules programmed per information category are used for this purpose. A preferred set of rules states: if information is present only in the first or the second hybrid map, it is taken over into the new hybrid map; if information in the first and second hybrid map coincides within a tolerance, it is taken over from the first hybrid map; if information in the second hybrid map deviates from the first hybrid map beyond a tolerance, it is taken over from the second hybrid map. Thus, the first hybrid map is trusted just as long as it does not have gaps or the new mapping does not give clear indications that the information is outdated. These rules may also be only partially implemented.

The transfer decision preferably is a selection to transfer the environment contour from the first hybrid map, the second hybrid map, both hybrid maps, or no hybrid map. This selection preferably is made for all information in an information category, i.e. in this embodiment for all environment contours, and this applies mutatis mutandis to the other information categories to be discussed below. By selecting only the first hybrid map, environment contours are not to be changed, while selecting only the second hybrid map means that the environment contour is to be overwritten everywhere, at least where new environment contours have been acquired. Selecting both hybrid maps will result in a combination of the environment contours. If no hybrid map is selected at all, the new hybrid map will not contain any environment contours either. It is then no longer suitable for navigation, but may still be useful for other purposes such as diagnostics.

The transfer decision preferably is a selection to take the trail to be driven from the first hybrid map, the second hybrid map, both hybrid maps, or no hybrid map. Selecting the first map means that the trajectory to be driven is not changed, for example because it was edited by hand and possibly the physical trail from which it originated is damaged or no longer exists. Selection of the second hybrid map modifies the previous trajectory, at least in the newly recorded areas. When both maps are selected, a common trajectory is determined in overlapping sections. Again no hybrid map can be selected, in that case, the new hybrid map does not contain a trail or trajectory any more, which still may be added in further steps.

The hybrid map preferably comprises at least one of reflector positions, additional codes and position codes as information category. So far, only a first information category and a second information category have been specifically mentioned, namely trail (or trajectory) and environment contour. A possible third and/or fourth information category relates to reflectors and the additional codes already mentioned in the introduction. Reflectors are in principle part of the surrounding contour, but with particularly reliable detection and usually also particularly well known positions. Additional codes generally contain some information for the vehicle. Preferably, reliable absolute positions are detected from additional codes, where the map and subsequent navigation can be reliably anchored.

The transfer decision preferably is a selection to transfer the reflector positions from the first hybrid map, the second hybrid map, both hybrid maps, or no hybrid map. This selection is to be understood quite similar to the one above for the environment contour. The difference is that the reflector population usually is changed intentionally to support navigation. Nevertheless, it is quite conceivable that reflectors degrade, become obscured or damaged, or be lost without deliberate action. To address the respective actual situation, it may make sense to keep the reflectors from the first hybrid map, transfer only the new reflectors from the second hybrid map, combine all reflectors from both maps, or not include any reflectors at all in the new hybrid map.

The transfer decision preferably is a selection to transfer the additional codes from the first hybrid map, the second hybrid map, both hybrid maps, or no hybrid map. The transfer of additional codes from the first hybrid map is particularly useful if the original additional codes have been damaged or no longer exist. Conversely, it may be that only the information of the additional codes that now exist should be used, and only the second hybrid map is selected for this purpose. The additional codes of both hybrid maps can be combined. Finally, it is conceivable to use additional codes during mapping and merging, but then not to transfer them to the new hybrid map, for example because no corresponding code reader is provided in the navigation mode.

The hybrid map preferably comprises additional codes as an information category, wherein additional codes are assigned to a position along the trail. During mapping, the additional codes are detected with a code reader that only has a certain detection range. This code reader could be emulated for virtual additional codes during navigation. Instead, it is more robust to assign a coordinate along the trail to the additional codes. After all, the trail in effect forms a one-dimensional coordinate system for the position of the vehicle. According to this preferred embodiment, whether and when an additional code is considered to be detected does not depend on the estimated orientation of the vehicle or the reading range of a virtual code reader. An absolute position of an additional code is preferably corrected accordingly when assigning a trail coordinate if the additional code was not on the trail. Equivalent to drawing the additional code onto the trail as described would be a virtual code reader with an additional code considered to be detected as soon as a line perpendicular to the trail has crossed the additional code.

The first hybrid map and the second map preferably are represented as graphs, and the new hybrid map is generated from a fusion of the graphs. A node of such a graph corresponds to a position with associated additional information, while edges describe relative positions between nodes determined from overlapping sensor information. The two graphs, and thus the hybrid maps, are then fused or merged at at least one node corresponding to an identical or very similar position. The joint graph preferably is optimized, the optimization respecting the constraints imposed by the transfer decision.

The transfer decision preferably takes into account the condition of leaving unchanged or being allowed to change the graph of the first hybrid map. In a representation as a graph, a further condition preferably is added, which may or may not be optionally set for the generation of the new hybrid map: The graph representing the first hybrid map can be frozen, so to speak, and thus be taken over unchanged into the new hybrid map, or it can be allowed that its nodes are included in an optimization of the common graph. Preserving the original graph has the advantage that the old positions and coordinates do not change. Without this condition, the optimization usually is better, but at the price that the coordinate system can change and also structures can deform.

The trail preferably is a virtual trail, in particular learned from a physical trail or track. Hence, there may initially be a physical trail, such as an optical or magnetic trail on the floor. A virtual trail is learned based thereon, which accordingly exists only in the form of data. The virtual trail can be changed purely virtually and in principle also be created purely virtually, for example with the help of a graphic user interface on a configuration computer. As already explained in the introduction, a learning phase on the basis of a physical trail considerably simplifies the changeover to a navigation solution with contour detection sensors.

Subsequent navigation on the defined trajectory preferably is performed by respective corrections of the vehicle pose into the direction of the trail. The specific control instructions used to correct the pose may thus correspond to the control of a conventional trail guidance system using a physical trail. This further facilitates conversion, since the vehicle control system ultimately may receive the same information or commands as before.

A mapping apparatus for generating a new hybrid map for navigation of a vehicle by extending and/or modifying a first hybrid map with a second hybrid map comprises a contour detection sensor for detecting an environmental contour of an environment of the vehicle and a control and evaluation unit, with an embodiment of a method according to the invention being implemented in the control and evaluation unit. The merging of two hybrid maps into a new hybrid map may be performed offline, therefore the control and evaluation unit may be provided at least partially independent of the vehicle, for example in a computer connected only temporarily, a network or a cloud. The device preferably comprises a trail following sensor to follow a physical trail at least during the mapping of the first and/or second hybrid map, possibly also still supporting the later navigation.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The Figures of the drawing show in:

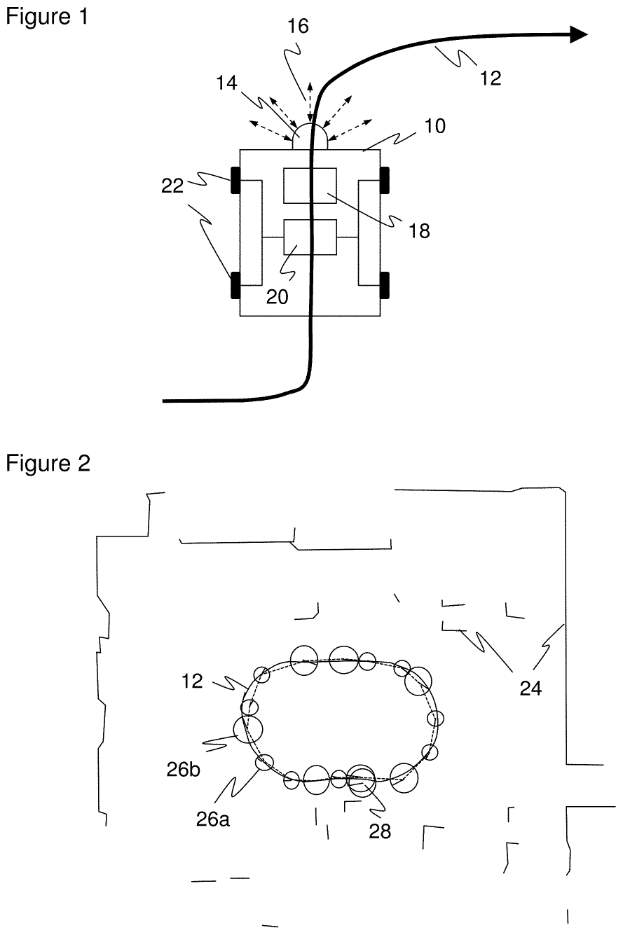

FIG. 1 a schematic representation of a vehicle with a contour measurement sensor navigating along a virtual trail;

FIG. 2 an exemplary map of an environmental contour and the trajectory of a vehicle specified on the basis of a trail;

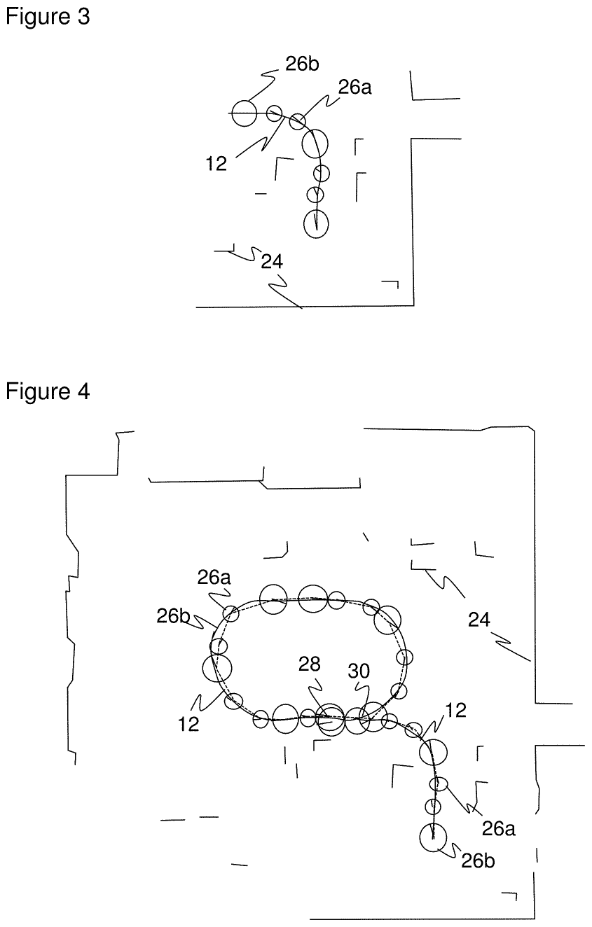

FIG. 3 an exemplary second map that is to be used to modify the map according to FIG. 2;

FIG. 4 a new map composed of the maps shown in FIGS. 2 and 3;

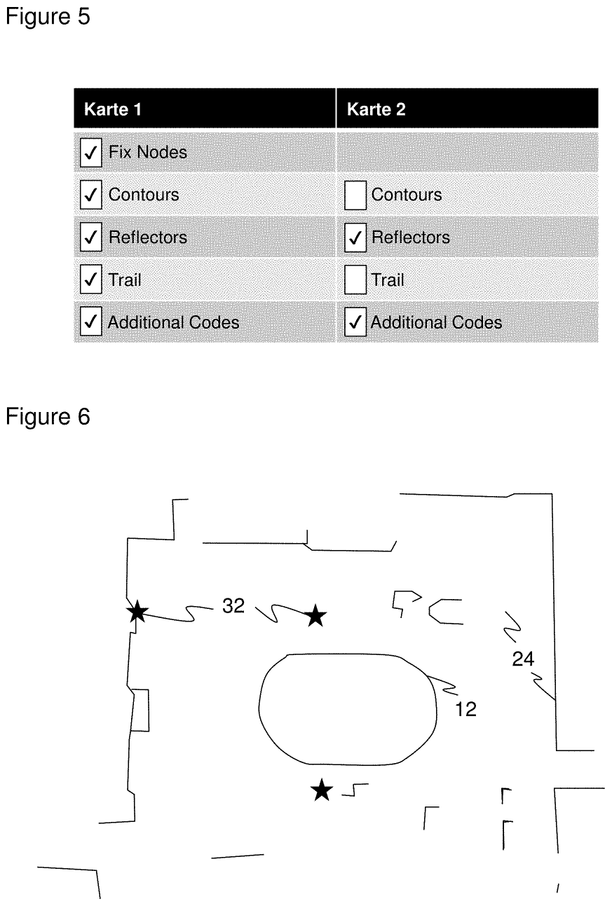

FIG. 5 an exemplary selection of the information categories of two maps to be merged that are to be transferred to a new map;

FIG. 6 an exemplary map illustrating added reflectors;

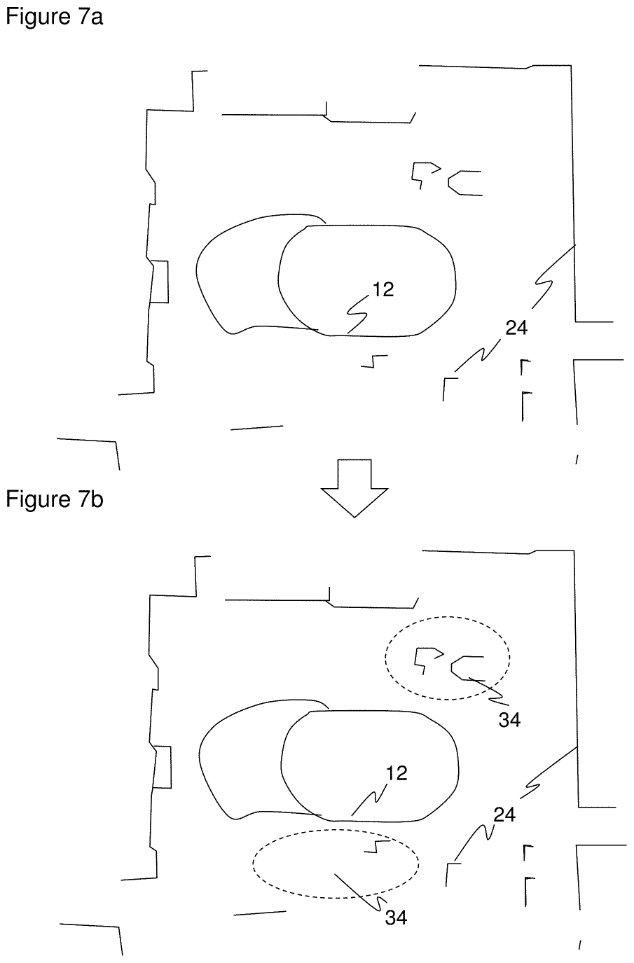

FIG. 7a-b exemplary maps illustrating a modified environment contour in the initial state and in the modified state of the maps;

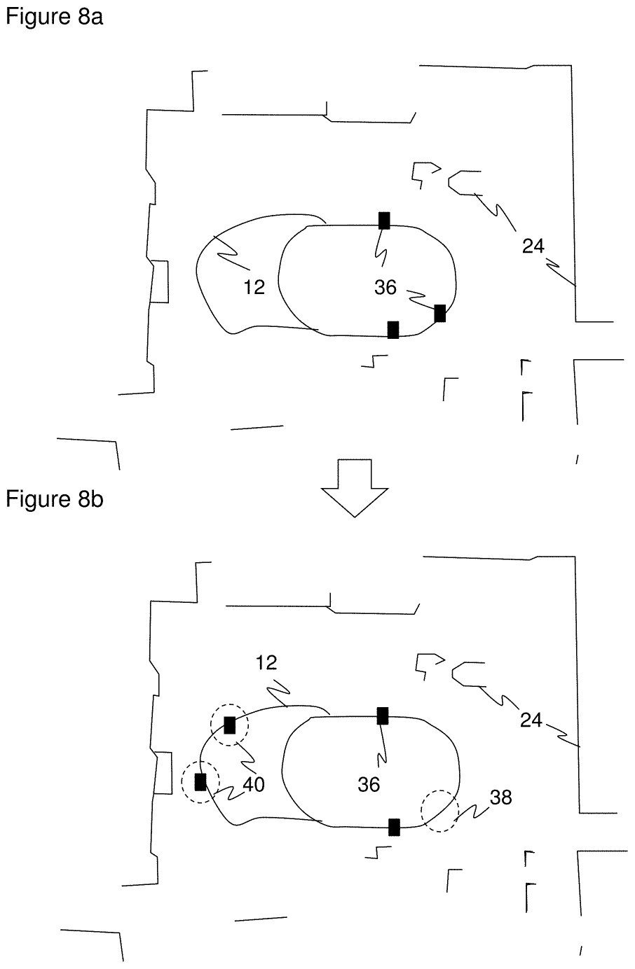

FIG. 8a-b exemplary maps illustrating modified additional codes in the initial state and in the modified state of the maps;

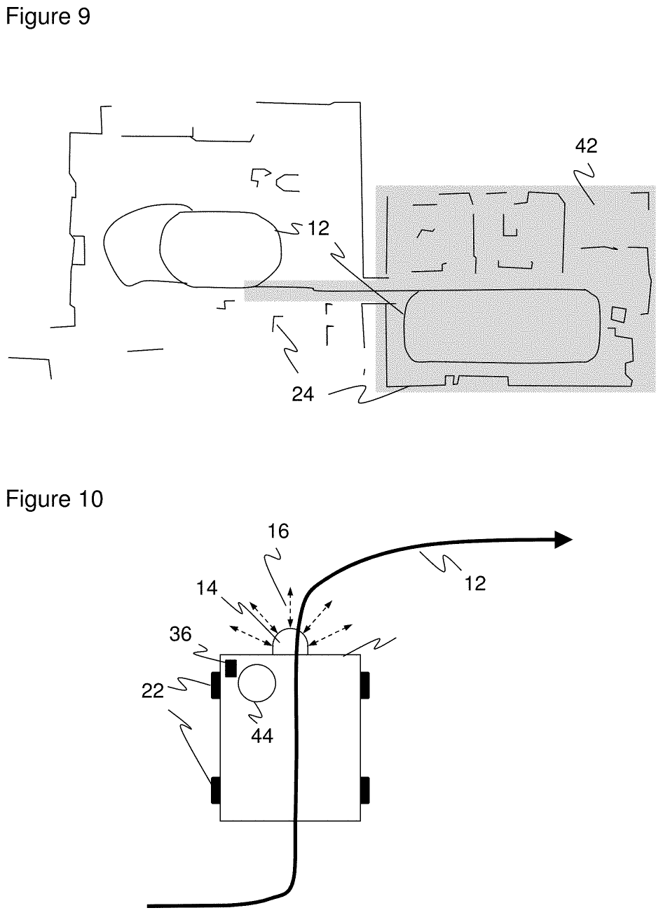

FIG. 9 an exemplary map where a new area is added;

FIG. 10 a top view of a vehicle having a code reader that passes an additional code; and

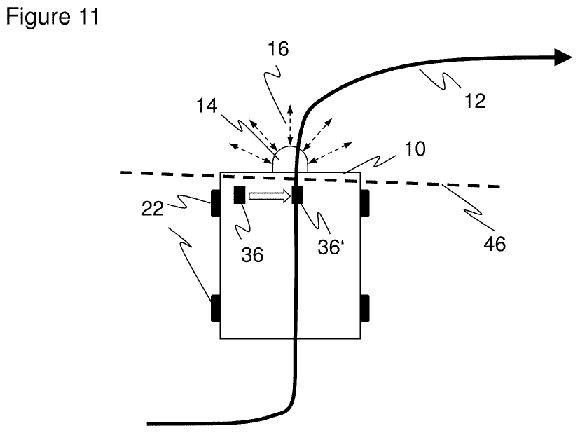

FIG. 11 a top view similar to FIG. 10, where the additional code now is drawn onto the trail, or is considered to have been read when it has been passed by a line perpendicular to the trail.

FIG. 1 shows a schematic top view of a vehicle 10 navigating along a trail 12. The vehicle 10 has a contour detection sensor 14, shown here as a laser scanner. The laser scanner transmits scanning beams 16 in different directions and measures the distance to a respective scanned object point using a time-of-flight (TOF) method. As an alternative to a laser scanner or LIDAR, other contour detection sensors 14 are conceivable, for example based on a 3D camera, in particular a stereo camera, time-of-flight camera or triangulation camera, a RADAR or on ultrasound. A plurality of contour detection sensors 14 can complement each other for a larger field of view or all-round view.

A control and evaluation unit 18 is connected to the contour detection sensor 14 in order to evaluate its contour measurement data, to create a map of the environment of the vehicle 10 in a learning phase in a manner to be described, and then to navigate using the map in a subsequent operating phase. The control and evaluation unit 18 in turn is in communication with a vehicle control unit 20. The vehicle control unit 20 acts on the wheels 22 or axles thereof to accelerate, brake and steer the vehicle. Conversely, vehicle control unit 20 may also receive sensor information from wheels 22. Control and evaluation unit 18 may be at least partially implemented in contour detection sensor 14. A separation of control and evaluation unit 18 and vehicle control unit 20 is to be understood as exemplary only, they may at least partially be implemented together. At least parts of the control and evaluation unit 18 may be provided externally to the vehicle 10, for example in a computer wirelessly connected thereto, a network or a cloud. In particular, the creation or modification of a map based on measurement data of the contour detection sensor 14 can be done externally.

In a preferred embodiment, the vehicle 10 initially navigates in a learning phase using trail guidance sensors or line guidance sensors that are not shown and are known per se and detect a physical trail 12. The contour detection sensor 14 is also active and generates contour information of the surroundings or environment of the trail 12, and the contour information is combined to form a map. During further operation, the physical trail 12 is no longer needed and can be replaced by a virtual trail 12 that merely indicates the desired trajectory. Navigation at operation time is based on a localization of the vehicle 10 by means of a comparison of currently acquired contour information by the contour detection sensor 14 and the map. The control and evaluation unit 18 can also use the virtual trail 12 and the contour information to generate control data for the vehicle control system 20 of the same type as previously generated with the trail guidance sensor from the physical trail 12. The method of using a virtual trail guidance sensor with creation of a map and subsequent localization and navigation based on the map, which has only been summarily described, is explained in detail in the German patent application with file number 10 2019 123 659.2 and its U.S. counterpart Ser. No. 17/008,921, which is herewith incorporated by reference.

FIG. 2 shows an example of a map of contour 24 in the surroundings or environment of trail 12. Such a map is created from numerous measurements taken by contour measurement sensor 14 at various positions along trail 12, with the individual contours being combined to form contour 24.

Although the generation of one map is assumed to be known and the invention relates to the combination of two maps for an update (remapping), it will facilitate understanding of the invention to at first briefly discuss the individual steps of an automated mapping. However, this exemplary advantageous method can be replaced by other ways to arrive at a map with the corresponding information.

During at least one acquisition or mapping trip along the trail 12, the ego motion of the vehicle 10 is estimated from the measurement data of the contour detection sensor 14. The trail 12 is preferably still physically present during this phase and is detected by at least one trail or line detection sensor. Preferably, any existing additional codes along the trail 12 are read by a code reader. The acquired contours, trails and code data are pre-processed and stored. Based on the estimated vehicle motion, the data is arranged in a map.

However, errors in the estimation of the vehicle's motion accumulate over time, resulting in inconsistencies in the map. One way of correcting such errors is to use positions that have already been visited and which the vehicle 10 passes over again, so-called loop closures. Preferred are loop closures at positions with an additional code that contains the corresponding absolute position and thus forms a reliable anchor point.

A particularly advantageous representation of the map is a graph whose nodes are positions and whose edges are connections along the trail 12. FIG. 2 shows two different types of nodes of different sizes. At small nodes 26a, reference contours are stored for the position. These are used during navigation to correct the estimated position by scan matching with currently acquired contours. No reference contours are stored at large nodes 26b. However, data on the trail 12 and detected additional codes can also be stored at all nodes 26a-b.

In such a representation, a graph-based optimization can use the loop closures 28 to correct errors in the estimation of the vehicle motion. At the position of a loop closure 28, the respective positions are superimposed or, if an absolute position is known from an additional code, shifted to this absolute position. This shift is distributed to the other nodes 26a-b during optimization. When a node 26ab is moved, associated contour, trail and code data are also moved.

To further improve the map, the acquired trail 12 can not only be entered into the map, but also be used algorithmically. Trails 12 detected multiple times, whether from multiple visits of the same position or through the use of multiple trail guidance sensors, are drawn on top of each other and combined into a single trail 12, respectively. Additional codes read multiple times are also united at one position.

FIG. 3 shows a second map that is acquired, for example, at a later time using the mapping method explained with reference to FIG. 2. The second map is acquired in order to adapt the original map according to FIG. 2 to changes in the navigation environment or in the route, or in order to open up new areas.

FIG. 4 shows a new map as a combination of the first, original map according to FIG. 2 and the second, additionally acquired map according to FIG. 3. The combination is preferably done using the representation as a graph, but could also be implemented in other ways. In order to combine or merge two graphs, a connection by at least one edge must be created. This is preferably done at a loop closure 30 in an overlapping region. A suitable loop closure 30 is preferably found automatically, as was previously the case for a loop closure 28 for error correction when acquiring a single map, while additional codes and/or measurements of the trail 12 can be used for assistance, but a manual specification, for example in a graphical user interface, is also conceivable.

The two connected graphs can then be optimized as a single graph as described above with reference to FIG. 2. Considering only the case that two graphs are merged is to be understood without loss of generality. An arbitrary number of graphs—and thus also maps—can be treated accordingly, in particular by pairwise merging one after the other.

In principle, it is conceivable to optimize all information of the combined map at the same time. In that case, all old and new information is combined in a new map which is as accurate as possible. According to the invention, however, it should be possible to make a specific transfer decision so that the map updates only affect a part of the map. This does not only mean a local restriction, although this is conceivable. The maps in question are so-called hybrid maps, because they include several different information categories. It should be possible to make a transfer decision per information category as to how the information from the two source maps is transferred to the new map.

FIG. 5 shows an example of how a user can configure the transfer in the respective information categories. Exemplary information categories are listed in the rows of the table in FIG. 5, and by checking the box, the user can specify which map is to be used as the source in the respective information category. In most cases, it is also possible to select both maps, which then combines data or information from both maps or graphs, or to select no map to exclude the corresponding information category from the new map. The check marks in FIG. 5 are purely exemplary.

The information categories according to FIG. 5 and the effects of a respective selection of maps within an information category are now explained in more detail. This enumeration of information categories is to be understood as a non-exhaustive example, where in particular not all specified information categories need to be available in a specific embodiment.

A first information category concerns a representation as a graph and, if selected, fixes the nodes of the graph of the first map. An optimization of the merged graph is thus forbidden to move the nodes already known from the first map. This has the advantage that already known positions and the coordinate system of the map do not change. Thus, positions stored by the user also retain their validity. However, at the same time, the chance to compensate for earlier optimization errors in the first map is not used. A corresponding option for fixing nodes for the second map, although possible in principle, does not really make sense, by the way, since it would only exclude the use of optimization options without any advantages, since there are no previously used known positions or coordinates in the second map.

Alternatively, if the nodes of the first map are not selected as fixed, only one node is fixed to ensure the convergence of the optimization. All other nodes from both graphs can change their positions. This may deform the map or move it to a different position in the coordinate system. The coordinate system of the new map thus no longer matches the original first map, and depending on the situation, not only in the form of an offset, but even a deformation of structures. However, if, for example, the user does not have to rely on the metric positions, for example because only the trajectory given by the trail 12 is to be followed, more freedom is created for the optimization to correct errors. A more accurate new map is created, where it is even possible that earlier errors of the first map are reduced using the additional information of the second map. In this mode, maps can be composed of individual sections, which can be used to perform mapping in several separate acquisition trips rather than having to cover the complete course in one run.

A second information category concerns the contours 24 acquired by the contour detection sensor 14. The contours 24 are preferably still retained during the optimization, independently of the selection, and used, for example, for the search for loop closures 28, 30. Finally, however, they are only transferred to the new map according to the selection.

If contours 24 are only selected from the first map, the new measurements of contours 24 of the second map are ignored. For example, the second map has been included because the desired trail 12 or trajectory has changed, or additional codes have been changed. However, the contours 24 themselves have proven to be useful for localization and may have already been manually edited, so no change is desired in this regard. Conversely, contours may only have been selected from the second map. In this case, the structures in the environment have changed significantly, for example because shelves or movable walls have been moved, so that the original contours 24 are no longer well suited for localization.

It makes sense, for example, to transfer contours 24 from both maps to the new map if the mapped area has been expanded, i.e. new areas have become accessible. If the new map is not to contain any contours 24 at all, then this map can only be used for navigation to a very limited extent, since it is no longer possible to make a comparison to correct the localization. However, the user possibly wants to transfer only trails 12 or additional codes into a CAD drawing or the like, for which the option is offered.

A third information category concerns reflectors. Such reflectors are placed everywhere or at particularly critical points in order to further support navigation through particularly reliable detection by the contour detection sensor 14. In principle, therefore, reflectors can be understood as part of the contour 24, so that the explanations are largely the same. Reflector information is preferably used during optimization whatever the selection, for example, to search for loop closures 28, 30. The selection determines if and how they are finally transferred to the new map.

If reflectors of only the first map are selected, any additional reflectors detected with the second map are ignored. This makes sense if the changes for which the map is being updated affect contours 24, trail 12 and/or additional codes, but the previous reflector positions have proven themselves and have possibly already been edited manually. Conversely, if only reflectors of the second map are selected, the previous reflectors of the first map are discarded and replaced by the new reflectors of the second map. For example, the reflector population has been greatly changed by both removing old reflectors and mounting new reflectors. Preferably, the second map has been acquired in such a way that all reflectors currently present have been detected.

If reflectors of both maps are selected, all known reflectors are taken over, and overlapping detections of the same reflector are merged. Example cases are an extension of the navigation area or the addition of reflectors at certain locations to improve localization. Also with regard to reflectors, there is the possibility of not including them in the new map at all. One reason for this could be that there are too many mismeasurements of reflectors, for example because workers in the area are wearing reflector bands.

A fourth information category concerns the trail 12 and the path or trajectory of the vehicle 10 that the trail 12 defines, respectively. Again, data of the trail 12 are preferably used during optimization, independently of the selection, for example in order to superimpose trails 12 that have been acquired a plurality of times as described above with reference to FIG. 2. The selection determines if and how trail 12 information is finally transferred to the new map.

If only the first map is selected, the trajectory remains unchanged. The changes that required updating the map therefore do not affect the intended trajectory. It is possible that trail 12 does not even exist physically and can therefore only be preserved in this way, or that the trajectory was manually edited. If, on the other hand, only the second map is selected as the source of the new trail 12, the desired trajectory has changed, and the old trajectories should only be used to the extent that this is still currently specified in the second map. For this option, all new trails should have been visited and thus acquired in the second map.

If both maps are allowed as a source of the new trail, all trail data will be transferred. Overlapping trails will be combined to a single trail, similar to FIG. 2 above within the optimization of a single map. A typical use case again is an area extension. It is also conceivable that new trails 12 were placed in the area already covered by the first map, but that not all of the previous trails 12 were covered when the second map was acquired, in particular because this was no longer possible and the corresponding trail 12 is no longer physically present. There is also the option of not including any trails 12 in the new map, for example because the vehicle 10 is to navigate freely. A better map once again is generated if trails 12 define the trajectories at least during mapping and are at least temporarily available for optimization.

A fifth information category concerns additional codes. Like other information categories, additional codes can also be used during optimization, independently of the selection, in particularly to detect and locate loop closures 28, 30. However, it should be noted that additional codes known from the first map may not be present or may have been moved.

When selecting additional codes only of the first map, their positions have not changed. It is possible that at least some additional codes are no longer physically present, but are only used virtually. Conversely, when selecting additional codes of the second map only, all previously known additional codes of the first map are discarded. Care should be taken to ensure that the second map includes all additional codes that are still relevant.

A combination of additional codes from both maps transfers all additional codes that have been acquired in only one map. If additional codes are detected in both maps at very close positions, or if they are unique additional codes that occur in both maps, they are preferably merged in the new map, or the maps are unified in a way that is compatible with the additional code having been detected twice. Use cases include extending the navigation area with more additional codes in the new areas and/or adding additional codes in known areas to assist in localization or to provide additional control instructions to the vehicle 10. The option to not include additional codes in the new map is useful, for example, if the vehicle 10 does not have a code reader at all.

Following this explanation of the individual information categories and the selection options for merging two maps within each of the information categories, a number of examples will now be considered. These are use cases of particular relevance where updating the map is necessary or useful. However, this is not intended to limit the possible combinations of selections.

FIG. 6 shows an exemplary map illustrating added reflectors 32. In this use case, it is noticed during navigation operation that localization is unreliable in certain areas. As a countermeasure, the additional reflectors 32 are added.

A preferred selection, as explained with reference to FIG. 5, for this case could be: Fix Nodes: Yes; Contours: Map 1 Yes, Map 2 No; Reflectors: Map 1 Yes, Map 2 Yes; Trail: Map 1 Yes, Map 2 No; Additional Codes: Map 1 Yes, Map 2 No.

With this selection, the new reflectors 32 are additionally entered in the new map. If reflectors have already been entered in the first map, they are retained. Overlapping reflectors from both maps are merged. In the other information categories, the first map remains untouched.

For this example, only the new map is shown in FIG. 6. This is based on a combination of an original first map without the reflectors 32 and a second map with at least those sections in which the reflectors 32 are detected.

FIGS. 7a-b show maps illustrating a use case with a changed environment or contour 24. FIG. 7a shows the original first map and FIG. 7b shows the new map after combination with a second map.

In this case, the trails 12 are already mapped or even manually edited, for example by adding the left arc as a virtual trail. Then, however, the environment has changed in such a way that a reliable comparison with the existing map is no longer possible. Therefore, the environment should be re-mapped, but the trails should remain. A complete remapping would in particular cause a manually added part of the trail to disappear.

A preferred selection, as explained with reference to FIG. 5, for this case could be: Fix Nodes: Yes; Contours: Map 1 No, Map 2 Yes; Reflectors: Map 1 No, Map 2 Yes; Trail: Map 1 Yes, Map 2 No; Additional Codes: Map 1 Yes, Map 2 No.

Thus, the trails 12 and additional codes of the first map are retained, while the changed environment is re-mapped in contour 24 and reflectors. The selection with respect to the additional codes could be varied within this use case depending on whether or not anything has changed in the navigation environment in this regard. In the example shown in FIG. 7b, the change in the environment is limited to the fact that some contours in areas 34 have disappeared.

FIGS. 8a-b show maps illustrating a use case with modified additional codes 36. Thus, additional codes 36 have been removed from some locations 38 and reapplied or moved to other locations 40. Again, FIG. 8a shows the original first map and FIG. 8b shows the new map after combination with a second map.

In this use case, the first map is to remain largely unchanged, but the additional codes 36 are to be newly detected and entered, where in this example it is assumed that the changes in the additional codes 36 have been extensive so that the previous information in this regard can no longer be used at all.

A preferred selection, as explained with reference to FIG. 5, for this case could be: Fix Nodes: Yes; Contours: Map 1 Yes, Map 2 No; Reflectors: Map 1 Yes, Map 2 No; Trail: Map 1 Yes, Map 2 No; Additional Codes: Map 1 No, Map 2 Yes.

FIG. 9 shows a map where a new area 42 is to be added to an existing first map without remapping areas already known. Only the new map is shown, with the area 42 added by means of the second map highlighted in gray for illustration purposes.

A preferred selection, as explained with reference to FIG. 5, for this case could include all information categories, i.e. Fix nodes: Yes; Contours: Map 1 Yes, Map 2 Yes; Reflectors: Map 1 Yes, Map 2 Yes; Trail: Map 1 Yes, Map 2 Yes; Additional codes: Map 1 Yes, Map 2 Yes.

This selection assumes that there are almost no conflicts between the information of the two maps because the maps cover different areas. This exactly has been the initial scenario, where the second map should be prevented from again covering the area of the first map.

Without its own representation in a Figure, yet another use case will be discussed. The scenario is that a first map has been acquired with a different sensor configuration, in particular a different contour detection sensor 14, than the vehicle 10 will use for navigation. In particular, multiple vehicles 10 should be able to share at least portions of a map. The detection of contours 24 and also reflectors 32 differs from sensor configuration to sensor configuration, so in this respect the vehicle 10 needs a map that matches the current sensor configuration. However, the differences are quite subtle to the human eye, which is the reason that no example images are presented in a Figure for that case.

A lot of work in the form of manual editing may have already been invested in the first map that was acquired with a different sensor configuration. Therefore, there is a requirement to maintain this state for all affected vehicles 10. Only the actual sensor data, i.e. the contour 24 and, if applicable, the reflectors 32, are to be exchanged. The coordinate system including known positions, the trails or trajectories and the additional codes 36 are not to be modified.

A preferred selection, as explained with reference to FIG. 5, for this case could be:: Fix Nodes: Yes; Contours: Map 1 No, Map 2 Yes; Reflectors: Map 1 No, Map 2 Yes; Trail: Map 1 Yes, Map 2 No; Additional Codes: Map 1 Yes, Map 2 No.

This selection corresponds to that explained with reference to FIG. 7a-b in a changed environment, but in a different initial situation and with a different acquisition of the second map, in this case due to a changed sensor configuration.

The selection illustrated in FIG. 5 is only an example. The user interface where the specifications for the information categories are selected can take any form. Preferably, a live view is offered during the acquisition of the second map or during the merging, where a user can follow whether all relevant data are acquired or transferred as desired. If necessary, the user can intervene and expand the second map or change his selection of the data to be transferred.

It is also conceivable that the system automatically decides which data is taken from which map in order to reduce manual effort. For example, similar data or data that exists only once can be retained or merged, while priority is given to the more recent recording in the case of contradictory data.

FIG. 10 illustrates, based on a top view of a vehicle 10, a problem that may arise in the detection of additional codes 36. It has already been explained that the additional codes 36 are preferably detected during mapping with a code reader. In subsequent navigation operation, the additional codes 36 need not be physically present, but in some embodiments are replaced by virtual additional codes 36. To ensure that the control instructions of the virtual additional codes 36 are followed, a virtual code reader is implemented to emulate the behavior of the physical code reader.

In order to ensure the most accurate control and determination of the route section, the reading area 44 of the code reader should be small, for example 15 cm wide. Otherwise, the localization will be imprecise. On the other hand, if the reading area 44 is small, the code reader may not pass over the additional code 36 with sufficient accuracy due to random variations in the trail control, and thus may not be able to read it. As a result, there may be false controls. Depending on the technology of the code reader and associated additional code 36, code information of the additional code 36 may also not be detected for other reasons. RFID tags may not be located or may be located incorrectly due to reflections and shielding. Barcodes cannot be read if the orientation of the detection is unfavorable so that the reading line does not cross all code elements. Optical 2D codes can no longer be read from perspectives that are too flat.

Of course, a virtual code reader can avoid these physical limitations of the respective technology, i.e., it can simply not emulate that aspects. However, the case where the emulated reading area 44 misses the additional code 36 as in FIG. 10 is still possible.

FIG. 11 illustrates, in another top view of a vehicle 10, a method for a virtual code reader that avoids the problem with a reading area 44 that does not match with a code area with sufficient accuracy. In fact, two alternative solutions are shown.

A first option is to draw or shift the captured additional code 36 onto the trail 12 as a virtual additional code 36′. A control command encoded in the additional code 36 is to be executed at the time when the additional code 36 is detected. This, in turn, corresponds to a specific position along the trail 12. Therefore, the position of the code can be reassigned to only one coordinate corresponding to the position along the trail 12. If the additional code 36 encodes an absolute position, this absolute position is corrected for the virtual additional code 36 according to the offset from the trail 12. The virtual additional code 36′ is considered to have been read when the vehicle 10 reaches the corresponding position on the trail 12.

An alternative possibility, which is mathematically equivalent in principle, is to replace the rectangular or circular, narrowly defined original reading area 44 in the virtual code reader with a virtual measuring line 46, which is arranged perpendicular to the trail 12 in each case. As soon as the virtual measuring line 46 sweeps over the additional code 36 at its position learned in the map, the additional code 36 is considered to have been read, and its control command is executed. The virtual measuring line 46 ultimately does nothing but project the position of the additional code 36 onto a corresponding position on the trail 12. Instead of a virtual measuring line 46, a rectangle with the width of the virtual measuring line 46 could also be used as the reading area 44.

The extent of the virtual measurement line 46 must be limited to approximately the width of the vehicle 10, since otherwise additional codes 36 that do not belong to the currently traveled section of the trail 12 would possibly also be taken into account. Similarly, in the first option described above, only virtual additional codes 36′ are drawn onto the trail 12 that are sufficiently close to the trail 12 and thus would in principle be detected by a code reader.

1. A method for generating a new hybrid map by at least one of extending and modifying a first hybrid map with a second hybrid map, the hybrid map being used for the navigation of a vehicle (10) in a navigation area and including a plurality of information categories, one information category comprising a trajectory of the vehicle (10) to be driven, which trajectory is predefined by a trail (12), and one information category comprising a surrounding contour (24) of the trail (12), wherein a transfer decision is made for each of the information categories as to whether information from the first hybrid map, the second hybrid map, or both the first hybrid map and the second hybrid map is transferred to the new hybrid map.

2. The method according to claim 1,
wherein the first hybrid map is generated in a first mapping process and/or the second hybrid map is generated in a second mapping process at a later time, wherein in a mapping process the vehicle (10) travels along at least parts of the trail (12) and records the surrounding contour (24) of the trail (12) with a contour detection sensor (14).

3. The method according to claim 1,
wherein the transfer decision is made by a specification per information category.

4. The method according to claim 3,
wherein the transfer decision is made by a selection in a user interface.

5. The method according to claim 1,
wherein the transfer decision is made automatically.

6. The method according to claim 5,
wherein the transfer decision is made according to at least one of the following criteria: if information is present only in the first or the second hybrid map, it is taken over into the new hybrid map; if information in the first and second hybrid map coincides within a tolerance, it is taken over from the first hybrid map; if information in the second hybrid map deviates from the first hybrid map beyond a tolerance, it is taken over from the second hybrid map.

7. The method according to claim 1,
wherein the transfer decision is a selection to transfer the environment contour (24) from the first hybrid map, the second hybrid map, both hybrid maps, or no hybrid map.

8. The method according to claim 1,
wherein the transfer decision is a selection to take the trail (12) to be driven from the first hybrid map, the second hybrid map, both hybrid maps, or no hybrid map.

9. The method according to claim 1,
wherein the hybrid map comprises at least one of reflector positions (32), additional codes (36) and position codes as information category.

10. The method of claim 9,
wherein the transfer decision is a selection to transfer the reflector positions (32) from the first hybrid map, the second hybrid map, both hybrid maps, or no hybrid map.

11. The method of claim 9,
wherein the transfer decision is a selection to transfer the additional codes (36) from the first hybrid map, the second hybrid map, both hybrid maps, or no hybrid map.

12. The method according to claim 1,
wherein the hybrid map comprises additional codes (36) as an information category, and wherein additional codes (36) are assigned to a position along the trail (12).

13. The method according to claim 1,
wherein the first hybrid map and the second map are represented as graphs and the new hybrid map is generated from a fusion of the graphs.

14. The method according to claim 13,
wherein the transfer decision takes into account the condition of leaving unchanged or being allowed to change the graph of the first hybrid map.

15. The method according to claim 1 wherein the trail (12) is a virtual trail.

16. The method according to claim 15,
wherein the trail (12) is learned from a physical trail (12).

17. A mapping apparatus (14, 18) for generating a new hybrid map for the navigation of a vehicle (10), the device having a contour detection sensor (14) for detecting an environmental contour (24) of an environment of the vehicle (10) and a control and evaluation unit (18) configured to execute a method for generating the new hybrid map by at least one of extending and modifying a first hybrid map with a second hybrid map, the hybrid map being used for the navigation of a vehicle (10) in a navigation area and including a plurality of information categories, one information category comprising a trajectory of the vehicle (10) to be driven, which trajectory is predefined by a trail (12), and one information category comprising a surrounding contour (24) of the trail (12), wherein a transfer decision is made for each of the information categories as to whether information from the first hybrid map, the second hybrid map, or both the first hybrid map and the second hybrid map is transferred to the new hybrid map.
